(19) United States
(12) Patent Application Publication
(10) Pub. No.: US 2013/0202437 A1
(43) Pub. Date: Aug. 8, 2013

(54) Roller Push Belt for Wind Turbine Drive Train Applications

(71) Applicant: Richard A. Himmelmann, Beloit, WI (US)

(72) Inventor: Richard A. Himmelmann, Beloit, WI (US)

(73) Assignee: Clipper Windpower, LLC, Carpinteria, CA (US)

(21) Appl. No.: 13/368,568

(22) Filed: Feb. 8, 2012

(51) Int. Cl. F03D 11/02; F16H 7/18

(52) U.S. Cl. 416/170 R; 474/140

(57) ABSTRACT

A wind turbine with a roller push belt drive train is disclosed. The wind turbine comprises a tower with a nacelle mounted to the tower. A hub is rotatably mounted to the nacelle. A plurality of blades radially extends from the hub, which is mounted to a main shaft within the nacelle. In one embodiment, the main shaft is mounted to a drive sprocket. A driven sprocket is mounted to a generator input shaft of a generator. The driven sprocket is proximally aligned in the same plane as the drive sprocket, but the drive and driven sprockets do not contact each other. A roller push belt transfers motion from the drive sprocket to the driven sprocket. The roller push belt comprises a guide track around the perimeter of the circumferences of the drive and driven sprockets and a plurality of roller elements arranged along the guide track.

### TECHNICAL FIELD

The present disclosure relates generally to wind turbines and, more particularly, to a roller push belt drive train for a wind turbine.

### BACKGROUND

In recent years, wind turbines have been integrated into electric power generation systems to create electricity to support the needs of both industrial and residential applications. These wind turbines capture the kinetic energy of the wind and convert it into electricity. A typical wind turbine includes a set of two or three large blades mounted to a hub. Together, the blades and hub are referred to as the rotor. The rotor is connected to a main shaft, which in turn, is operatively connected by a drive train to a generator. When the wind causes the rotor to rotate, the kinetic energy of the wind is captured and converted into rotational energy. The rotational energy of the rotor is then translated along the main shaft, and the rotational speed of the main shaft may be increased by the drive train. The drive train delivers this increased rotational speed to the generator, which then converts it into electricity.

A typical drive train consists of a speed increasing gearbox. Typical gearboxes have large housings containing one or more stages of gears connected to the main shaft and generator input shaft. The gearbox depends on precision helical gears to transmit the power from the low speed turbine shaft to the high speed generator input shaft. In a conventional gearbox, the alignment of the gears is crucial to the operation of the drive train. The operating torques are transmitted from gear to gear through a relatively small number of gear teeth that are in mesh with each other at any particular time. If any component of the gearbox (i.e. housing, gears, or shafts) deflects under the load, the gears become misaligned. When the gears become misaligned, they experience very high local contact stresses, which lead to gear pitting and eventual gear failure. The large size of these gearboxes and the extreme loads handled by them make gearboxes even more susceptible to deflections and resultant premature wear, damage, and reduced life span. Furthermore, maintenance and replacement of damaged gearbox parts can be difficult, complex, and expensive.

Thus, there exists a need for a simplified, reliable wind turbine drive train. This invention is directed to solving this need and provides a way to reduce the cost and complexity of the drive train by eliminating the conventional gearbox and the need for precise gear alignment.

### SUMMARY OF THE INVENTION

According to one embodiment of the present disclosure, a wind turbine is disclosed. The wind turbine may comprise a tower, a nacelle mounted at a top of the tower, a hub mounted for rotation to the nacelle, a plurality of blades radially extending from the hub, a main shaft rotating with the hub, at least one drive sprocket mounted onto the main shaft, at least one driven sprocket proximally aligned in the same plane as the drive sprocket, at least one roller push belt connecting the drive sprocket to the driven sprocket, at least one generator input shaft mounted onto the driven sprocket, and at least one generator connected to the generator input shaft and driven by the driven sprocket. The roller push belt of the wind turbine may comprise a guide track along the perimeter of the drive sprocket and driven sprocket, and a plurality of roller elements arranged along the guide track.

According to another embodiment, a drive train for a wind turbine is disclosed. The drive train may comprise a drive sprocket mounted to a main shaft of a wind turbine, a driven sprocket mounted to a generator input shaft of a generator of the wind turbine, and a roller push belt connecting the drive sprocket to the driven sprocket. The roller push belt of the wind turbine may comprise a guide track following the perimeter of the circumferences of the drive sprocket and the driven sprocket, and a plurality of roller elements adapted for engagement with the drive sprocket and the driven sprocket. The roller elements of the roller push belt may be arranged along the guide track of the roller push belt.

According to yet another embodiment, a method of increasing the generator input speed of a wind turbine is disclosed. The method may comprise providing a drive sprocket mounted to a main shaft of a wind turbine and a driven sprocket mounted to a generator input shaft of a generator of the wind turbine. The method may further comprise providing a roller push belt to connect the drive sprocket to the driven sprocket. The roller push belt may comprise a guide track following the perimeter of the circumferences of the drive sprocket and the driven sprocket with the guide track having an unloaded side and a compression side, and a plurality of roller elements arranged along the guide track and adapted for engagement with the drive sprocket and the driven sprocket. The method may further comprise using the rotational motion of the drive sprocket to push the roller elements of the roller push belt along the guide track from the unloaded side to the compression side of the drive sprocket, and transmitting the rotational motion of the drive sprocket to the driven sprocket through the roller elements along the guide track from the compression side to the unloaded side of the driven sprocket.

Other advantages and features will be apparent from the following detailed description when read in conjunction with the attached drawings.

### BRIEF DESCRIPTION OF THE DRAWINGS

FIG. 1 is a perspective view of a wind turbine made according to the present disclosure;

FIG. 2 is a perspective, partial cutaway view of the wind turbine of FIG. 1;

FIG. 3 is a perspective view of a drive train according to one embodiment of the present disclosure; and

FIG. 4 is an enlarged sectional view of the drive train of FIG. 3 taken along line 4-4 of FIG. 3.

### DETAILED DESCRIPTION

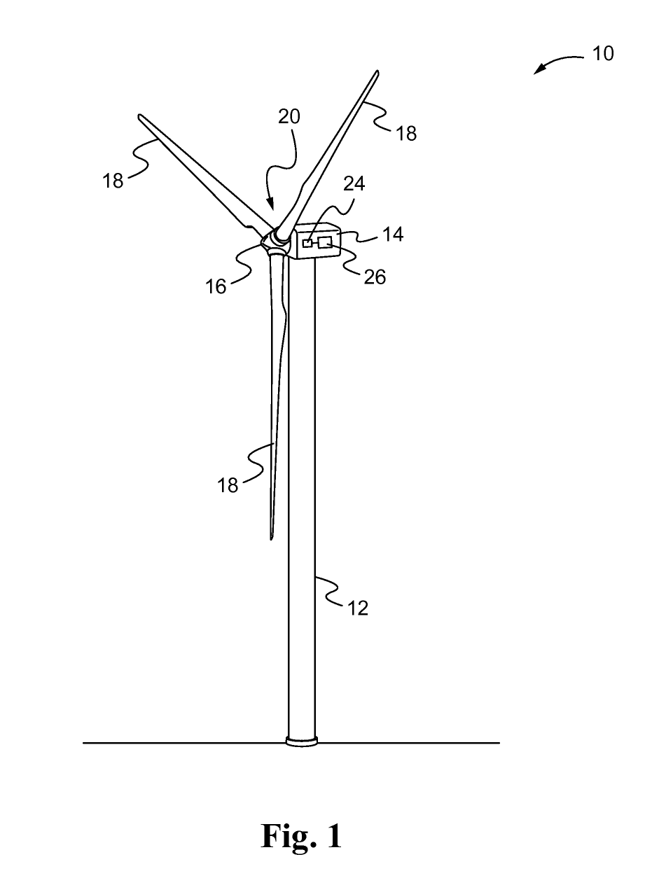

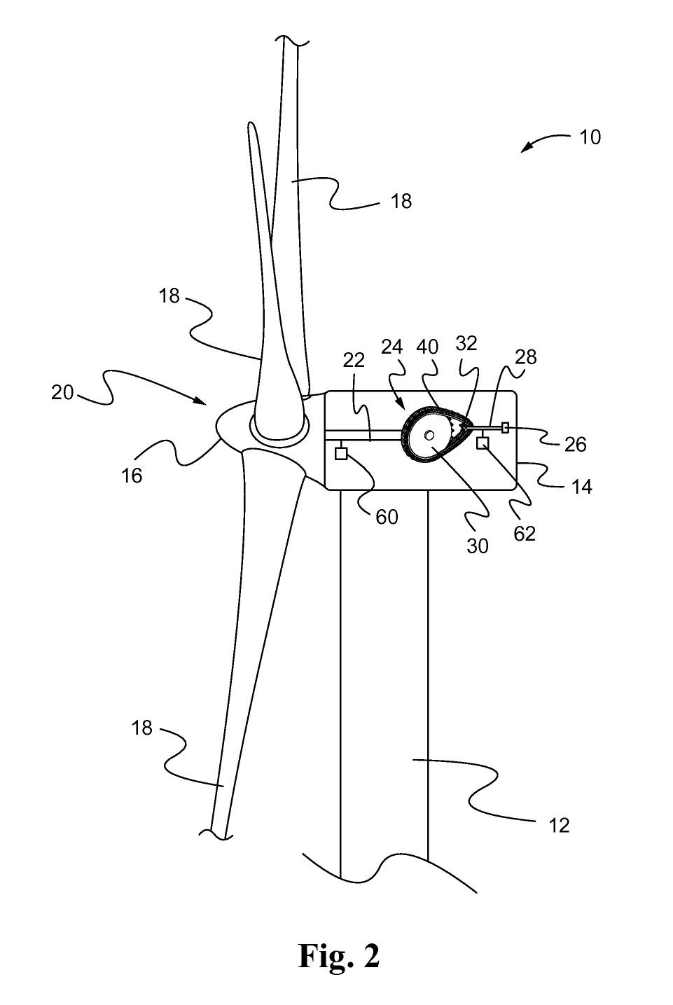

Referring to FIGS. 1 and 2, a wind turbine 10 according to one embodiment of the present disclosure is shown. While all components of the wind turbine 10 are not shown or described, the wind turbine 10 may include a vertically oriented tower 12. A nacelle 14 may be rotatably mounted on top of the tower 12 with a hub 16 mounted for rotation to the nacelle 14. Radially extending from the hub 16 are a plurality of blades 18. Together, the hub 16 and blades 18 are referred to as the rotor 20. As shown best in FIG. 2, the rotor 20 is mounted to a main shaft 22 within the nacelle 14. Also contained within the nacelle 14 may be a drive train 24 and generator 26. The main shaft 22 may be connected to the drive train 24 which, in turn, is connected to the generator 26 via a generator input shaft 28. [14] When the wind moves the blades 18 and causes the rotor 20 to rotate, the kinetic energy of the wind is converted into rotational energy. The rotational energy is transferred from the rotor 20 through the main shaft 22 to the drive train 24. The drive train 24 increases the rotational speed of the main shaft 22 and delivers this increased speed through the generator input shaft 28 to the generator 26. The generator 26 then converts this rotational energy into electricity.

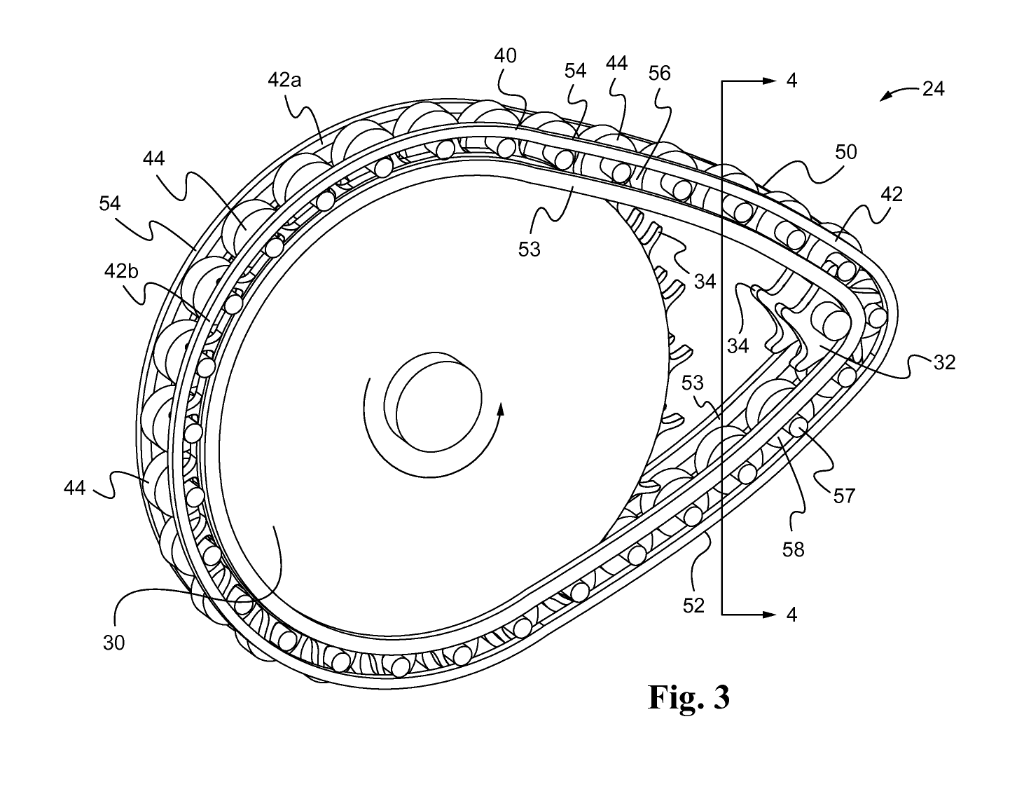

As shown in FIG. 3, the drive train 24 of the wind turbine includes a drive sprocket 30 and a driven sprocket 32. The drive sprocket 30 and driven sprocket 32 are proximal to each other and vertically aligned in the same plane. However, the drive sprocket 30 and driven sprocket 32 do not contact each other and do not mesh with each other. The drive sprocket 30 may have a larger diameter than the driven sprocket 32. For example, the diameter of the drive sprocket 30 may be, including but not limited to, 3 meters, whereas the diameter of the driven sprocket 32 may be, including but not limited to, 1 meter, yielding a speed ratio of 3 to 1. It will be understood that other diameters for the drive and driven sprockets 30, 32 are certainly possible and within the scope of this disclosure. The drive sprocket 30 may be mounted on and be driven by the main shaft 22, which in turn may be supported by bearings and support structure 60. Similarly, the driven sprocket 32 may be mounted on the generator input shaft 28 and be supported by bearings and support structure 62.

A roller push belt 40 may be used to connect the drive sprocket 30 to the driven sprocket 32. The roller push belt 40 may include a guide track 42 and a plurality of roller elements 44. The guide track 42 follows the perimeter of the circumferences of the drive sprocket 30 and the driven sprocket 32, and includes an unloaded side 50 and a compression side 52. The plurality of roller elements 44 are rotatably mounted within the guide track 42.

More specifically, the guide track 42 may include left and right tracks 42a and 42b, wherein each track 42a and 42b includes radially inner and outer rings 53 and 54. In so doing, each set of rings 53 and 54 form an annulus 56 for receipt of the roller elements. To facilitate such receipt and rotation of the roller elements 44, each roller element 44 may include an axle 57 from which radially extends disc 58.

The roller push belt 40 transfers the rotational energy from the drive sprocket 30 to the driven sprocket 32 through the individual roller elements 44. The series of roller elements 44 are not fixedly attached to each other; however, they can contact each other and are free to push each other along the annuli 56 defined by the guide tracks 42a and 42b. Since the roller elements 44 are not physically connected to one another, they can tolerate misalignment without significantly impacting their performance. By reducing the need for precise sprocket location, the roller push belt 40 is a more reliable drive train 24 than a conventional gearbox and thus, the hardware of the drive train 24 has a longer life span, thereby reducing the overall cost of maintenance for the wind turbine 10.

Each roller element 44 may also be adapted for engagement with both the drive sprocket 30 and the driven sprocket 32. According to one embodiment of the present disclosure, both the drive sprocket 30 and driven sprocket 32 have sprocket teeth 34. The sprocket teeth 34 on the drive and driven sprockets 30, 32 are adapted to engage a single roller element 44 and cradle the roller element 44 in between two adjacent sprocket teeth 34. Thus, it should be clear that the sprocket teeth 34 are not provided for meshing between the drive sprocket 30 and driven sprocket 32. It will be understood that although as described above, the roller elements 44 engage with the drive and driven sprockets 30, 32 through sprocket teeth 34, any means of engagement may be possible and covered within the scope of the present invention. In addition, although the roller elements 44 shown in FIG. 3 are round, the roller elements 44 may also be square or some other geometric shape to engage with the drive and driven sprockets 30, 32.

The roller elements 44 of the roller push belt 40 transmit motion from the drive sprocket 30 to the driven sprocket 32. As the drive sprocket 30 rotates (being driven by the rotation of the main shaft 22), the drive sprocket 30 picks up a roller element 44 with one of its sprocket teeth 34 from the unloaded side 50 of the guide track 42. The drive sprocket 30 cradles the roller element 44 in between two of its sprocket teeth 34 and drives the roller element 44 around the circumference of the drive sprocket 30 until the guide track 42 forces the roller element 44 off of the drive sprocket 30 and onto the compression side 52 of the guide track 42.

Motion is then transmitted from the drive sprocket 30 to the driven sprocket 32 by allowing the roller elements 44 to push against one another on the compression side 52 of the guide track 42. On the compression side 52 of the guide track 42, the roller elements 44 push on the trailing end of the roller element 44 immediately in front of it. Under compression, the series of roller elements 44 form a solid load path from the drive sprocket 30 to the driven sprocket 32. Each roller element 44 pushes and transmits the motion to the roller element 44 in front of it, thereby delivering the rotational energy to the driven sprocket 32. When the roller element 44 reaches the end of the compression side 52 of the guide track 42, its linear motion is captured by the sprocket teeth 34 of the driven sprocket 32. In so doing, a more efficient drive train 24 is formed.

After the sprocket teeth 34 of the driven sprocket 32 receive the roller element 44 from the compression side 52 of the guide track 42, the driven sprocket 32 cradles the roller element 44 in between two of its sprocket teeth 34 and guides the roller element 44 around the circumference of the driven sprocket 32. The guide track 42 then forces the roller to leave the driven sprocket 32 and re-enter the unloaded side 50 of the guide track 42. In this way, the driven sprocket 32 is driven by the rotational motion of the drive sprocket 30. The rotational energy of the driven sprocket 32 is then translated through the mounted generator input shaft 28 and delivered to the generator 26, which converts the rotational energy into electricity.

With the roller push belt 40, torque generating forces are spread around a large percentage of the drive sprocket 30 circumference, thereby lowering the forces applied at any particular point. The stress of the load imparted by such torque on the drive train 24 is thereby also spread across the large circumference of the drive sprocket 30 to the individual roller elements 44. By lowering the localized forces, the localized stresses will also decrease. This creates a more reliable and longer lasting drive train 24 and allows for the size, mass, and cost of the hardware to be reduced.

In addition, since the circumference of the drive sprocket 30 is larger than the circumference of the driven sprocket 32, the rotational speed of the drive sprocket 30 (i.e., the original wind turbine rotational speed, or rotational speed of the main shaft 22 and rotor 20) is increased by the smaller driven sprocket 32. Since the driven sprocket 32 has an increased rotational speed, the associated generator input shaft 28 delivers a higher rotational speed to the generator 26. This higher rotational generator speed enables the size and mass of the generator 26 to be reduced while still outputting the desired power, thereby reducing the cost of the overall generator system of the wind turbine. The higher rotational generator speed also increases the fundamental frequency of the electrical output of the generator 26. This higher fundamental frequency from the generator 26 enables the overall size, mass, and cost of the power conversion equipment to be reduced as well.

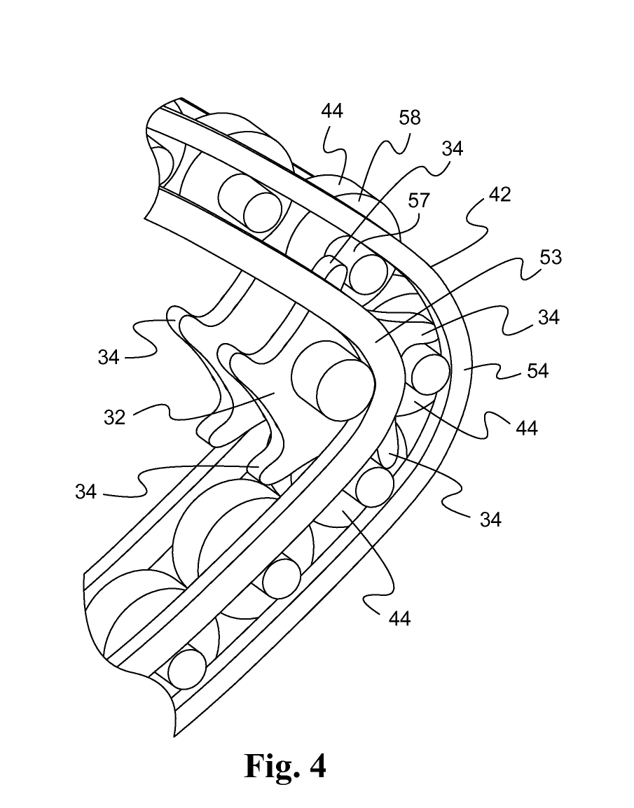

Although only one drive sprocket 30, one driven sprocket 32, one roller push belt 40, one generator input shaft 28, and one generator 26 have been shown in FIGS. 1-4, it will be understood that this is merely for exemplary purposes and that any number of drive sprockets, driven sprockets, roller push belts, generator input shafts, and generators may be used according to the present disclosure. In fact, according to another embodiment of the present disclosure, it would be desirable to have two or more stages of the drive train 24 described above within a wind turbine in order to multiply the wind turbine speed (i.e. rotor 20 and main shaft 22 speed) and deliver an increased speed to the generator or generators. In this way, the size and cost of the generators could be further reduced.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

What is claimed is:

1. A wind turbine comprising:
a tower;
a nacelle mounted at a top of the tower;
a hub mounted for rotation to the nacelle;
a plurality of blades radially extending from the hub;
a main shaft rotating with the hub;
at least one drive sprocket mounted onto the main shaft;
at least one driven sprocket proximally aligned in the same plane as the drive sprocket;
at least one roller push belt connecting the drive sprocket to the driven sprocket, wherein the roller push belt comprises:
a guide track along the perimeter of the drive sprocket and driven sprocket; and
a plurality of roller elements arranged along the guide track;
at least one generator input shaft mounted onto the driven sprocket; and
at least one generator connected to the generator input shaft and driven by the driven sprocket.

2. The wind turbine of claim 1, wherein the drive sprocket has a larger diameter than the driven sprocket.

3. The wind turbine of claim 1, wherein the drive sprocket does not contact the driven sprocket.

4. The wind turbine of claim 1, wherein each roller element is shaped either round, square, or another geometric shape.

5. The wind turbine of claim 1, wherein both the drive sprocket and driven sprocket are adapted for engagement with the roller elements.

6. The wind turbine of claim 1, wherein both the drive sprocket and driven sprocket have sprocket teeth shaped to engage with the roller elements.

7. The wind turbine of claim 1, not including a gearbox.

8. A drive train for a wind turbine comprising:
a drive sprocket mounted to a main shaft of a wind turbine;
a driven sprocket mounted to a generator input shaft of a generator of the wind turbine; and
a roller push belt connecting the drive sprocket to the driven sprocket, wherein the roller push belt comprises:
a guide track following the perimeter of the circumferences of the drive sprocket and the driven sprocket; and
a plurality of roller elements adapted for engagement with the drive sprocket and the driven sprocket, wherein the roller elements are arranged along the guide track.

9. The drive train of claim 8, wherein the drive sprocket has a larger diameter than the driven sprocket.

10. The drive train of claim 9, wherein the drive sprocket does not contact the driven sprocket.

11. The drive train of claim 10, wherein the drive sprocket and the driven sprocket are proximal to each other and vertically aligned in the same plane.

12. The wind turbine of claim 11, wherein both the drive sprocket and driven sprocket are adapted for engagement with the roller elements.

13. The drive train of claim 12, wherein both the drive sprocket and driven sprocket have sprocket teeth shaped to engage with the roller elements.

14. The drive train of claim 8, wherein the roller push belt has an unloaded side and a compression side.

15. The drive train of claim 14, wherein the roller elements of the roller push belt are pushed along the circumference of the drive sprocket from the unloaded side to the compression side by the rotational motion of the drive sprocket and subsequently transmit the rotational motion of the drive sprocket to the driven sprocket from the compression side to the unloaded side along the circumference of the driven sprocket.

16. A method of increasing the generator input speed of a wind turbine comprising:
providing a drive sprocket mounted to a main shaft of a wind turbine, and a driven sprocket mounted to a generator input shaft of a generator of the wind turbine;
providing a roller push belt to connect the drive sprocket to the driven sprocket, the roller push belt comprising:
a guide track following the perimeter of the circumferences of the drive sprocket and the driven sprocket, the guide track having an unloaded side and a compression side, and
a plurality of roller elements arranged along the guide track and adapted for engagement with the drive sprocket and the driven sprocket;
using the rotational motion of the drive sprocket to push the roller elements of the roller push belt along the guide track from the unloaded side to the compression side of the drive sprocket; and
transmitting the rotational motion of the drive sprocket to the driven sprocket through the roller elements along the guide track from the compression side to the unloaded side of the driven sprocket.

17. The method of claim 16, wherein the drive sprocket has a larger diameter than the driven sprocket.

18. The method of claim 17, wherein the drive sprocket does not contact the driven sprocket.

19. The method of claim 18, wherein both the drive sprocket and driven sprocket have sprocket teeth shaped to engage with the roller elements.

20. The drive train of claim 19, wherein the drive sprocket and the driven sprocket are proximal to each other and vertically aligned in the same plane.
